(19) United States
(12) Patent Application Publication
(10) Pub. No.: US 2023/0368991 A1
(43) Pub. Date: Nov. 16, 2023

(54) DC CIRCUIT SWITCHING APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yusuke ISAJI, Osaka-shi, Osaka (JP); Manami OKADA, Osaka-shi, Osaka (JP); Yuki FUJIMURA, Osaka-shi, Osaka (JP); Fumihiro KUZUHARA, Osaka-shi, Osaka (JP); Noboru WAKATSUKI, Osaka-shi, Osaka (JP)

(21) Appl. No.: 18/246,377

(22) PCT Filed: Aug. 2, 2021
(86) PCT No.: PCT/JP2021/028540

§ 371 Date: Mar. 23, 2023

(30) Foreign Application Priority Data
Sep. 25, 2020 (JP) 2020-161018

(51) Int. Cl. H01H 33/59; B60L 3/04; H02J 7/00

(52) U.S. Cl. CPC H01H 33/596; B60L 3/04; H02J 7/0031

(57) ABSTRACT

A DC circuit switching apparatus is connected between an automobile battery and a motor-side circuit and cuts off current that flows in two directions. The DC circuit switching apparatus includes a breaker that cuts off current, a first voltage holding circuit, which is constituted by a first diode and a first capacitor that are connected in series, that is provided in parallel to the breaker and is configured to allow power supply from the automobile battery to the motor-side circuit, and a second voltage holding circuit, which is constituted by a second diode and a second capacitor that are connected in series, that is provided in parallel to the breaker and is configured to allow power supply from the motor-side circuit to the automobile battery.

### CROSS-REFERENCE TO RELATED APPLICATIONS

This application is the U.S. national stage of PCT/JP2021/028540 filed on Aug. 2, 2021, which claims priority of Japanese Patent Application No. JP 2020-161018 filed on Sep. 25, 2020, the contents of which are incorporated herein.

### TECHNICAL FIELD

The present disclosure relates to a DC circuit switching apparatus.

### BACKGROUND

In general, in a device that is configured only by a power supply, a load, and switches, when current is cut off, the voltage of a mechanical switch rises to a power supply voltage at the same time as when the current is cut off, and there is a risk that an arc will occur. In order to break the circuit, the arc needs to be extinguished quickly and safely. In the case of an AC circuit, a zero point of voltage/current appears within 1/100 of a second if the frequency is 50 Hz, for example, and therefore an arc can be easily extinguished. In contrast thereto, in the case of a DC circuit, a zero point does not appear unlike an AC circuit, and therefore an arc is likely to be persistent, and there is a risk that damage or a fire will occur.

Therefore, there are cases where a mechanism for extinguishing an arc that includes a magnet is adopted. The inventors of the present disclosure have proposed a transient current switch circuit (see JP 5109156B and JP6471381B) in order to cut off a circuit current in a DC circuit while preventing an arc from occurring. In the transient current switch circuit, a series circuit including a transient current switch, a capacitor for delaying a voltage increase due to a transient current, and a diode for preventing a reverse current flowing from the capacitor is arranged in parallel to a current conducting switch, as shown in FIG. 16 of JP 6471381B, for example. It is possible to suppress the application of a voltage to the current conducting switch when the current conducting switch is turned off, by appropriately setting the capacitance of the capacitor, and therefore, an arc can be prevented from occurring.

When a mechanism for extinguishing an arc that includes a magnet is adopted, a large electromagnet is needed in order to reliably extinguish an arc, which leads to an unavoidable increase in the size and cost of the entire apparatus. Also, the transient current switch circuit has been described regarding a case of discharging in which current flows from a power supply to a load, but other cases need to be considered in order for the transient current switch circuit to be used in vehicles.

### SUMMARY

In view of the above problems, a DC circuit switching apparatus having a novel structure is disclosed that is compact, has a simple structure, and can suppress the occurrence of arcs in two directions.

The DC circuit switching apparatus of the present disclosure is a DC circuit switching apparatus that is connected between an automobile battery and a motor-side circuit and cuts off current that flows in two directions, and includes: a breaker configured to cut off the current; a first voltage holding circuit, which is constituted by a first diode and a first capacitor that are connected in series, that is provided in parallel to the breaker and is configured to allow power supply from the automobile battery to the motor-side circuit; and a second voltage holding circuit, which is constituted by a second diode and a second capacitor that are connected in series, that is provided in parallel to the breaker and is configured to allow power supply from the motor-side circuit to the automobile battery.

### Advantageous Effects

According to the present disclosure, a DC circuit switching apparatus having a novel structure can be provided that is compact, has a simple structure, and can suppress the occurrence of arcs in two directions.

### BRIEF DESCRIPTION OF DRAWINGS

FIG. 1 is a diagram schematically illustrating an electrical configuration on a path from an automobile battery to a motor-side circuit in a DC circuit switching apparatus according to a first embodiment of the present disclosure.

FIG. 2 is a diagram schematically illustrating an electrical configuration on a path from an automobile battery to a motor-side circuit in a DC circuit switching apparatus according to a second embodiment.

FIG. 3 is a diagram schematically illustrating an electrical configuration on a path from an automobile battery to a motor-side circuit in a DC circuit switching apparatus according to a third embodiment.

### DETAILED DESCRIPTION OF PREFERRED EMBODIMENTS

First, modes of the present disclosure will be enumerated and described.

The DC circuit switching apparatus of the present disclosure is: A DC circuit switching apparatus that is connected between an automobile battery and a motor-side circuit and cuts off current that flows in two directions, including: a breaker configured to cut off the current; a first voltage holding circuit, which is constituted by a first diode and a first capacitor that are connected in series, that is provided in parallel to the breaker and is configured to allow power supply from the automobile battery to the motor-side circuit; and a second voltage holding circuit, which is constituted by a second diode and a second capacitor that are connected in series, that is provided in parallel to the breaker and is configured to allow power supply from the motor-side circuit to the automobile battery.

According to the DC circuit switching apparatus of the present disclosure, the first voltage holding circuit that allows power supply from the automobile battery to the motor-side circuit is provided in parallel to the breaker. Accordingly, when the breaker cuts off current while power is supplied from the automobile battery to the motor-side circuit, the voltage of the breaker on the motor-side circuit side is kept at a voltage that is approximately equal to or close to the voltage of the breaker on the automobile battery side due to charges supplied from the first capacitor of the first voltage holding circuit. Therefore, the potential difference between contacts of the breaker is reduced, and as a result, the occurrence of an arc can be advantageously suppressed.

In addition, the second voltage holding circuit that allows power supply from the motor-side circuit to the automobile battery is provided in parallel to the breaker. Accordingly, when the breaker cuts off current while power is supplied from the motor-side circuit to the automobile battery, the voltage of the breaker on the automobile battery side is kept at a voltage that is approximately equal to or close to the voltage of the voltage of the breaker on the motor-side circuit side due to charges supplied from the second capacitor of the second voltage holding circuit. Therefore, the potential difference between contacts of the breaker is reduced, and as a result, the occurrence of arcs in two directions can be advantageously suppressed.

As described above, according to the DC circuit switching apparatus of the present disclosure, the occurrence of an arc in the DC circuit switching apparatus can be suppressed with a simple circuit structure, without needing a large breaker having a special structure. Therefore, a breaker having a common structure can be used, and the size of the DC circuit switching apparatus itself and the manufacturing cost thereof can be advantageously reduced. Moreover, the first voltage holding circuit and the second voltage holding circuit are provided in parallel to the breaker, and therefore bidirectional arc extinguishment can be advantageously realized in two states, namely a state in which power is supplied from the automobile battery to the motor-side circuit and a state in which power is supplied from the motor-side circuit to the automobile battery.

Note that the breaker includes a relay such as a contactor and a fuse. Also, the DC circuit switching apparatus need not be directly connected to the automobile battery, and may also be connected to the automobile battery via another member of another circuit.

It is preferable that the second voltage holding circuit allows power supply from a motor or a generator of the motor side circuit to the automobile battery. This is because, when the DC circuit switching apparatus is mounted on an electric car or a hybrid vehicle, the occurrence of arc can be advantageously suppressed when the breaker is cut off during regenerative braking operation or when power is being supplied from the generator.

It is preferable that the DC circuit switching apparatus includes a first resistor that is connected in parallel to the first capacitor. This is because, as a result of the first resistor being connected in parallel to the first capacitor, charges accumulated in the first capacitor can be discharged by the first resistor, when the breaker cuts off current.

It is preferable that the DC circuit switching apparatus includes a second resistor that is connected in parallel to the second capacitor. This is because, as a result of the second resistor being connected in parallel to the second capacitor, charges accumulated in the second capacitor can be discharged by the second resistor, when the breaker cuts off current.

It is preferable that the DC circuit switching apparatus includes a relay unit configured to connect and disconnect, to and from the breaker, the first voltage holding circuit and the second voltage holding circuit. As a result of the DC circuit switching apparatus including the relay unit, parallel connection of the first and second voltage holding circuits can be connected to and disconnected from the breaker, as needed. For example, by turning off the relay unit after the breaker is cut off when power is supplied from the automobile battery to the motor-side circuit, the occurrence of an issue where a terminal portion on the motor-side circuit side that is connected to the first capacitor becomes an electrically active portion can be reliably prevented. Also, by turning off the relay unit after the breaker is cut off when power is supplied from the motor-side circuit to the automobile battery, the occurrence of an issue in which a terminal portion on the automobile battery side that is connected to the second capacitor becomes an electrically active portion can be reliably prevented.

Specific examples of the DC circuit switching apparatus of the present disclosure will be described below with reference to the drawings. Note that the present disclosure is not limited to these illustrative examples and is defined by the claims, and all changes that come within the meaning and range of equivalency of the claims are intended to be embraced therein.

### First Embodiment

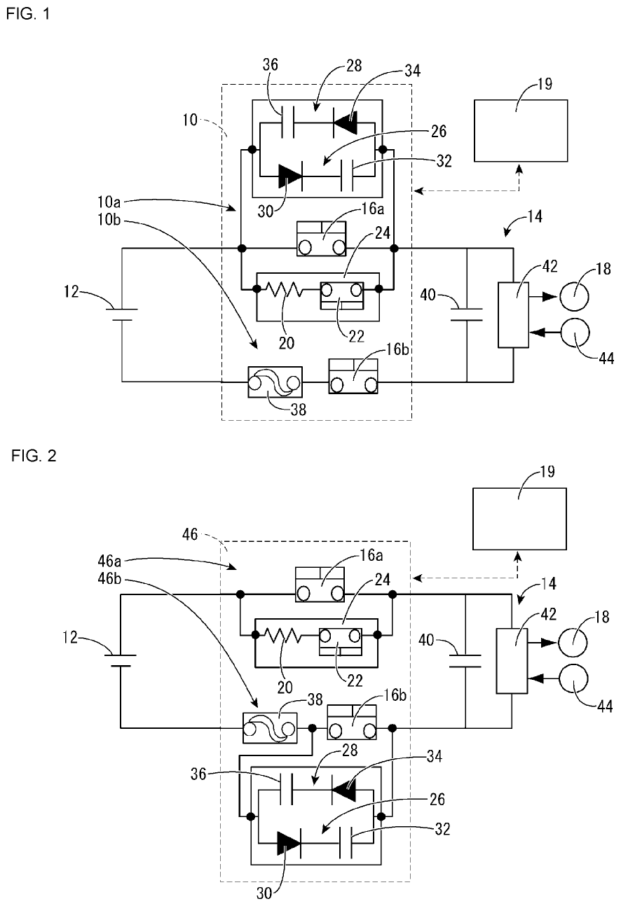

A DC circuit switching apparatus 10 of a first embodiment of the present disclosure will be described below with reference to FIG. 1. The DC circuit switching apparatus 10 is mounted on a vehicle (not shown) such as an electric car or a hybrid car, for example. As shown in FIG. 1, the DC circuit switching apparatus 10 is connected between an automobile battery 12 and a motor-side circuit 14. An automobile battery 12, which is a travel battery, supplies power to a motor 18 that causes a vehicle to travel and constitutes a motor-side circuit 14 via a main relay 16a (positive electrode side) and a main relay 16b (negative electrode side) that constitute breakers of the DC circuit switching apparatus 10. Turning on/off of the main relays 16a and 16b is controlled based on control signals from a controller 19 constituted by an ECU and the like. The main relays 16a and 16b, when turned on, connect between the automobile battery 12 and the motor 18, and supply power to the motor 18, and when turned off, cut off current between the automobile battery 12 and the motor 18, and stop power supply to the motor 18. Note that reference numerals may be given to only some of a plurality of the same members, and omitted from the other members.

### DC Circuit Switching Apparatus 10

The DC circuit switching apparatus 10 includes a positive electrode-side circuit section 10a provided on the positive electrode side and a negative electrode-side circuit section 10b provided on the negative electrode side, as shown in FIG. 1. The positive electrode of the automobile battery 12 is connected to the input side of the positive electrode-side circuit section 10a, and the negative electrode of the automobile battery 12 is connected to the input side of the negative electrode-side circuit section 10b. The output side of the positive electrode-side circuit section 10a is connected to the positive electrode side of the motor-side circuit 14, and the output side of the negative electrode-side circuit section 10b is connected to the negative electrode side of the motor-side circuit 14. The main relays 16a and 16b that are to be connected to the automobile battery 12 and the motor-side circuit 14 are respectively connected in the positive electrode-side circuit section 10a and the negative electrode-side circuit section 10b, between the input side and output side of each circuit section.

A precharge circuit 24 in which a precharge resistor 20 and a precharge relay 22 are connected in series is connected to the main relay 16a that connects between the automobile battery 12 and the positive electrode side of the motor-side circuit 14 so as to bypass the main relay 16a. In the first embodiment of the present disclosure, the precharge resistor 20 is connected to the input of the precharge relay 22, as shown in FIG. 1. Furthermore, a first voltage holding circuit 26 and a second voltage holding circuit 28 are provided in parallel to the main relay 16a that connects between the automobile battery 12 and the positive electrode side of the motor-side circuit 14. The first voltage holding circuit 26 is constituted by a first diode 30 and a first capacitor 32 that are connected in series, and the first diode 30 allows passage of current from the automobile battery 12 to the motor-side circuit 14. Also, the second voltage holding circuit 28 is constituted by a second diode 34 and a second capacitor 36 that are connected in series, and the second diode 34 allows passage of current from the motor-side circuit 14 to the automobile battery 12. That is, the second voltage holding circuit 28 allows passage of current from the motor 18 that constitutes the motor-side circuit 14 to the automobile battery 12. Moreover, the second voltage holding circuit 28 allows passage of current from a later-described generator 44 that constitutes the motor-side circuit 14 to the automobile battery 12.

Also, a fuse 38 is connected in series to the input of the main relay 16b that connects between the automobile battery 12 and the negative electrode side of the motor-side circuit 14. Note that, in the first embodiment of the present disclosure, a precharge circuit 24 is not connected to the main relay 16b that connects between the automobile battery 12 and the negative electrode side of the motor-side circuit 14, but a precharge circuit 24 may also be similarly provided for the main relay 16b as needed. The main relays 16a and 16b and the precharge relay 22 are each a relay that switches on and off by switching current supply to an exciting coil for moving a contact, and the on/off control thereof is performed based on a control signal from the controller 19.

### Automobile Battery 12

The output voltage of the automobile battery 12 is increased to a voltage in a range from 100 V to 400 V, for example, by connecting a plurality of chargeable secondary batteries in series. Also, the current capacity can also be increased by connecting a plurality of secondary batteries in parallel. A lithium ion secondary battery, a lithium polymer secondary battery, a nickel hydrogen battery, and the like can be used as this secondary battery. Also, a capacitor such as an electric double-layer capacitor (EDLC) can also be used in place of or in addition to the secondary battery. In this specification, secondary batteries also include capacitors.

### Motor-Side Circuit 14

The motor-side circuit 14 includes a large capacitance capacitor 40 and a DC/AC inverter 42 that are connected in parallel, for example. If the main relay 16a is switched on in a state in which the capacitor 40 is completely discharged, an extremely large charging current instantaneously flows therethrough to charge the capacitor 40. An extremely large charging current damages the contact of the main relay 16a, and therefore a precharge circuit 24 is provided in order to prevent damage caused by the charging current. In the first embodiment of the present disclosure, the precharge circuit 24 is provided in parallel to the main relay 16a. In the precharge circuit 24, the precharge resistor 20 is connected in series to the precharge relay 22 in order to limit the charging current flowing to the capacitor 40. The precharge resistor 20 limits the charging current flowing to the capacitor 40 to a small current when the precharge relay 22 is switched on. Note that the precharge resistor 20 may also be provided on the output side of the precharge relay 22.

The motor-side circuit 14 connects the automobile battery 12 to the motor 18 and the generator 44 via the DC/AC inverter 42. The DC/AC inverter 42 converts a DC voltage of the automobile battery 12 to an AC voltage, and supplies the resultant AC voltage to the motor 18, and converts an AC voltage of the generator 44 to a DC voltage, and charges the automobile battery 12 with the resultant DC voltage. Note that the motor 18 functions as a generator during regenerative braking, and charges the automobile battery 12. Note that the DC/AC inverter 42 is used in the first embodiment of the present disclosure, but a DC/DC converter may also be used.

Next, operations of the DC circuit switching apparatus 10 of the first embodiment of the present disclosure will be briefly described. In the first embodiment of the present disclosure, the main relay 16b of the DC circuit switching apparatus 10 is switched on when power supply is initiated. After the main relay 16a of the positive electrode-side circuit section 10a is switched off, the precharge relay 22 is switched on, and the capacitor 40 that constitutes the motor-side circuit 14 is precharged. Upon the capacitor 40 being precharged, the precharge relay 22 is switched off, and then the main relay 16a is switched on. Accordingly, when the main relay 16a is switched on in a state in which the capacitor 40 is completely discharged, an extremely large charging current can be prevented from instantaneously flowing therethrough to charge the capacitor 40. Therefore, the automobile battery 12 can be connected to the motor 18 so as to supply power to the motor 18 while preventing the contact of the main relay 16a from being damaged by the charging current flowing to the capacitor 40. Note that, in the following description, the state in which the main relays 16a and 16b are on and the precharge relay 22 is off is referred to as a normal state as appropriate.

When an anomaly is detected in the aforementioned normal state, the main relay 16a of the positive electrode-side circuit section 10a is switched off. Here, the first voltage holding circuit 26 that allows passage of current from the automobile battery 12 to the motor-side circuit 14 is provided in parallel to the main relay 16a. Therefore, even if an anomaly is detected when power is supplied to the motor 18 in the aforementioned normal state, and the main relay 16a cuts off current, charges are supplied from the first capacitor 32 of the first voltage holding circuit 26 to a node on the motor-side circuit 14 side of the main relay 16a. Accordingly, the voltage of the node of the main relay 16a can be kept at a voltage that is approximately equal to or close to the voltage of a node on the automobile battery 12 side of the main relay 16a, and the potential difference between contacts of the main relay 16a is reduced, and as a result, the occurrence of an arc can be advantageously suppressed.

Moreover, the second voltage holding circuit 28 that allows passage of current from the motor-side circuit 14 to the automobile battery 12 is provided in parallel to the main relay 16a of the positive electrode-side circuit section 10a. Accordingly, in the aforementioned normal state, the main relay 16a can cut off current when the motor 18, which functions as a generator during regenerative braking operation, charges the automobile battery 12, and when the generator 44 supplies power to the automobile battery 12. That is, the voltage of the node on the automobile battery 12 side of the main relay 16a can be kept at a voltage that is approximately equal to or close to the voltage of the node on the motor-side circuit 14 side of the main relay 16a due to charges supplied from the second capacitor 36 of the second voltage holding circuit 28 when current is cut off. Therefore, the potential difference between the contacts of the main relay 16a is reduced, and as a result, the occurrence of arcs in two directions can be advantageously suppressed.

When power supply is ended, the main relay 16a and the main relay 16b are switched off. Accordingly, the automobile battery 12 and the motor-side circuit 14 are completely separated and isolated. Note that the fuse 38 connected in series to the automobile battery 12 and the main relay 16b on the negative electrode side of the motor-side circuit 14 is provided so as to cut off any abnormal current when an abnormal current flows between the automobile battery 12 and the motor-side circuit 14.

Therefore, according to the DC circuit switching apparatus 10 of the present disclosure, the occurrence of arc in the DC circuit switching apparatus 10 can be suppressed with a simple circuit structure without needing a conventional large breaker having a special structure. Therefore, a contactor with an ordinary structure that does not include an arc-extinguishing member can be used as the main relay 16 that serves as a breaker, and the size of the DC circuit switching apparatus 10 itself and the manufacturing cost thereof can be advantageously reduced. Moreover, in the DC circuit switching apparatus 10 of the present disclosure, the first voltage holding circuit 26 and second voltage holding circuit 28 are provided in parallel with the main relay 16a. Therefore, arc extinguishment can be advantageously realized in two states in which arc direction differs, namely a state in which power is supplied to the motor 18 and a state in which the motor 18 or the generator 44 charges the automobile battery 12.

### Second Embodiment

In the DC circuit switching apparatus 10 of the first embodiment described above, the first voltage holding circuit 26 and the second voltage holding circuit 28 are provided in parallel to the main relay 16a provided in the positive electrode-side circuit section 10a, but there is no limitation to this. As in a DC circuit switching apparatus 46 of a second embodiment of the present disclosure shown in FIG. 2, the first voltage holding circuit 26 and second voltage holding circuit 28 may also be provided in parallel to the main relay 16b provided in a negative electrode-side circuit section 46b, instead of a positive electrode-side circuit section 46a. In this case as well, even if an anomaly is detected when power is supplied to the motor 18 in the aforementioned normal state, and the main relay 16b of the negative electrode-side circuit section 46b cuts off current, charges are supplied from the first capacitor 32 of the first voltage holding circuit 26 to a node on the motor-side circuit 14 side of the main relay 16b. Accordingly, the voltage of the node on the motor-side circuit 14 side of the main relay 16b can be kept at a voltage that is approximately equal to or close to the voltage of a node on the automobile battery 12 side of the main relay 16b, and the potential difference between contacts of the main relay 16 is reduced, and as a result, the occurrence of an arc can be advantageously suppressed. Also, in the aforementioned normal state, when the motor 18 or generator 44 supplies power to the automobile battery 12, the main relay 16b can cut off current. That is, the voltage of the node on the automobile battery 12 side of the main relay 16b can be kept at a voltage that is approximately equal to or close to the voltage of the node on the motor-side circuit 14 side of the main relay 16b due to charges supplied from the second capacitor 36 of the second voltage holding circuit 28 when current is cut off. Therefore, the potential difference between the contacts of the main relay 16b is reduced, and as a result, the occurrence of arcs in two directions can be advantageously suppressed. Therefore, it is apparent that, in the second embodiment of the present disclosure as well, effects similar to those of the first embodiment of the present disclosure are exhibited.

### Third Embodiment

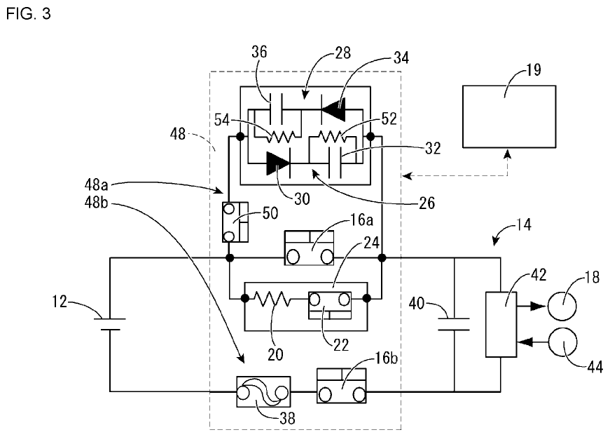

FIG. 3 shows a DC circuit switching apparatus 48 of a third embodiment of the present disclosure. The DC circuit switching apparatus 48 includes a relay unit 50, and the first voltage holding circuit 26 and second voltage holding circuit 28 that are provided in a positive electrode-side circuit section 48a are connected to the positive electrode of the automobile battery 12 via the relay unit 50. That is, the DC circuit switching apparatus 48 includes the relay unit 50 that is for connecting and disconnecting the first voltage holding circuit 26 and second voltage holding circuit 28 to and from a node on the automobile battery 12 side of the main relay 16a of the positive electrode-side circuit section 48a. Note that the relay unit 50 is a relay that switches on and off by switching current supply to an exciting coil for moving a contact, and the on/off control thereof is performed based on a control signal from the controller 19. When the relay unit 50 is on, the first voltage holding circuit 26 and second voltage holding circuit 28 are connected to the node on the automobile battery 12 side of the main relay 16a. When the relay unit 50 is off, the first voltage holding circuit 26 and second voltage holding circuit 28 are cut off from the node on the automobile battery 12 side of the main relay 16a.

As a result of provision of the relay unit 50, the parallel connection of the first voltage holding circuit 26 and second voltage holding circuit 28 can be connected to and disconnected from the main relay 16a as needed. For example, when the main relay 16a cuts off current after the relay unit 50 has been switched on while power is supplied to the motor 18, charges are supplied from the first capacitor 32 of the first voltage holding circuit 26 to the node on the motor-side circuit 14 side of the main relay 16a. Accordingly, the voltage of the node on the motor-side circuit 14 side of the main relay 16a can be kept at a voltage that is approximately equal to or close to the voltage of the node on the automobile battery 12 side of the main relay 16a, and the potential difference between the contacts of the main relay 16a is reduced, and as a result, the occurrence of arc can be advantageously suppressed. The charges accumulated in the first capacitor 32 of the first voltage holding circuit 26 are discharged by a first resistor 52 connected in parallel to the first capacitor 32. Thereafter, by switching off the relay unit 50, the occurrence of an issue where a terminal portion on the motor-side circuit 14 side that is connected to the first capacitor 32 becomes an electrically active portion can be reliably prevented.

Also, when power is supplied from the motor 18 or the generator 44 to the automobile battery 12, the main relay 16a can cut off current. That is, the voltage of the node on the automobile battery 12 side of the main relay 16a can be kept at a voltage that is approximately equal to or close to the voltage of the node on the motor-side circuit 14 side of the main relay 16a due to charges supplied from the second capacitor 36 of the second voltage holding circuit 28 when current is cut off. Therefore, the potential difference between the contacts of the main relay 16a is reduced, and as a result, the occurrence of arcs in two directions can be advantageously suppressed. The charges accumulated in the second capacitor 36 of the second voltage holding circuit 28 are discharged by a second resistor 54 connected in parallel to the second capacitor 36. Thereafter, by switching off the relay unit 50, the occurrence of an issue where a terminal portion on the automobile battery 12 side that is connected to the second capacitor 36 becomes an electrically active portion can be reliably prevented. When power supply is ended, the main relay 16b on the negative electrode side of the DC circuit switching apparatus 48 is switched off. Accordingly, the automobile battery 12 and the motor-side circuit 14 are completely separated and isolated.

### MODIFIED EXAMPLE

The first to third embodiments have been described above as specific examples of the present disclosure, but the present disclosure is not limited to the specific descriptions thereof. Modifications, improvements, and the like in a range in which objects of the present disclosure can be achieved are included in the present disclosure. For example, modified examples of the embodiments such as the following are included in the technical scope of the present disclosure.

In the first to third embodiments described above, the breakers are constituted by the main relays 16, but there is no limitation to this. For example, when the DC circuit switching apparatus of the present disclosure is applied to a circuit in which the precharge circuit 24 need not be provided, the breakers may also be constituted by fuses.

In the first to third embodiments described above, the DC circuit switching apparatus 10, 46, or 48 is directly connected to the automobile battery 12, but it is also possible to dispose the DC circuit switching apparatus of the present disclosure at a part that is connected to the automobile battery 12 via another member or another circuit.

In the first and second embodiments described above as well, similarly to the third embodiment, the first resistor 52 may also be connected in parallel to the first capacitor 32, and the second resistor 54 may also be connected in parallel to the second capacitor 36.

In the third embodiment described above as well, similarly to the second embodiment, the first voltage holding circuit 26 and the second voltage holding circuit 28 may also be provided in the negative electrode-side circuit section 48b.

1. A DC circuit switching apparatus that is connected between an automobile battery and a motor-side circuit and cuts off current that flows in two directions, comprising:
a breaker configured to cut off the current;
a first voltage holding circuit that is constituted by a first diode and a first capacitor that are connected in series, provided in parallel to the breaker, and is configured to allow power supply from the automobile battery to the motor-side circuit; and
a second voltage holding circuit that is constituted by a second diode and a second capacitor that are connected in series, provided in parallel to the breaker, and is configured to allow power supply from the motor-side circuit to the automobile battery.

2. The DC circuit switching apparatus according to claim 1, wherein the second voltage holding circuit allows power supply from a motor or a generator of the motor-side circuit to the automobile battery.

3. The DC circuit switching apparatus according to claim 1, further comprising a first resistor that is connected in parallel to the first capacitor.

4. The DC circuit switching apparatus according to claim 1, further comprising a second resistor that is connected in parallel to the second capacitor.

5. The DC circuit switching apparatus according to claim 1, further comprising a relay unit configured to connect and disconnect, to and from the breaker, the first voltage holding circuit and the second voltage holding circuit.

6. The DC circuit switching apparatus according to claim 2, further comprising a first resistor that is connected in parallel to the first capacitor.

7. The DC circuit switching apparatus according to claim 2, further comprising a second resistor that is connected in parallel to the second capacitor.

8. The DC circuit switching apparatus according to claim 3, further comprising a second resistor that is connected in parallel to the second capacitor.

9. The DC circuit switching apparatus according to claim 2, further comprising a relay unit configured to connect and disconnect, to and from the breaker, the first voltage holding circuit and the second voltage holding circuit.

10. The DC circuit switching apparatus according to claim 3, further comprising a relay unit configured to connect and disconnect, to and from the breaker, the first voltage holding circuit and the second voltage holding circuit.

11. The DC circuit switching apparatus according to claim 4, further comprising a relay unit configured to connect and disconnect, to and from the breaker, the first voltage holding circuit and the second voltage holding circuit.
